(19) United States
(12) Patent Application Publication
(10) Pub. No.: US 2005/0193147 A1
(43) Pub. Date: Sep. 1, 2005

(54) Data synchronization system and method

(75) Inventor: Nick Lin, Junghe City (TW)

Correspondence Address: BRUCE H. TROXELL, SUITE 1404, 5205 LEESBURG PIKE, FALLS CHURCH, VA, 22041, US

(73) Assignee: Vantech Software Company

(21) Appl. No.: 10/787,238

(22) Filed: Feb. 27, 2004

(51) Int. Cl. G06F 15/16

(52) U.S. Cl. 709/248

(57) ABSTRACT

A data synchronization system and a method synchronize the data in a server with a first renew data in the terminal through the network. The data comprises a characteristic data and a content data. A characteristic data difference distinguishing module is used to compare these characteristic data separately from server and terminal to further generate a first difference. An exactor chooses characteristic data in the server by a predetermined condition. Further, a content data difference distinguishing module compares the content data corresponding to the characteristic data and the content data in the terminal so as to generate a first content data difference. A composing module generates a content renew data by using the first content data difference, and generates an index renew data by using the first difference. Finally, the composing module constitutes the content renew data and the index renew data to generate the first renew data.

### FIELD OF THE INVENTION

The present invention relates to a data synchronization system and method, and more particular to the data synchronization system and method for synchronizing the data in a server and the data in a terminal through networking.

### BACKGROUND OF THE INVENTION

With the advent of network communications, computers can process data at a far end through networking. If a worker wishes to operate computers at various places, the synchronization problem in managing these data for these several computers are difficult.

Referring to FIG. 1, a diagram about synchronizing the data in multiple computers in accordance with the prior art is shown. A typical current method of synchronizing all data in these multiple computers is described, in which various computers 4 and 8 communicate through a network. A receiver 2 of the domestic computer 8 operated by a user 6 receives the data and file names of the data from foreign computers 4. There is a file of recording each timing of editing the data, and each recording timing, following the corresponding file name, may show on a monitor of the computer 8. The user 6 can then visually distinguish the recording times so as to determine which data is the new one to be updated or synchronized among the sharing computers 4 and 8.

In practice, synchronization operation among network computers according to aforesaid algorithms is obviously inefficient. Though improvement of the aforesaid algorithms by appropriate reprogramming is always possible theoretically, yet the limit of the practical network bandwidth does form a bottleneck toward such an improvement. Furthermore, memory capacity of current computer is also another problem, which limits the computer to be fully occupied at data transmission between network computers.

To solve the above-mentioned problem, the data compressing technique is definite a possible answer. However, the technique still can't transmit a large amount data rapidly through the network. For example, a user may be assessed to three desktop computers separately sited at three different places, such as a head office, a branch company, a home and so on. Under such an environment, synchronizing all data in these computers are extremely difficult due to the limitation on network bandwidth. In particular, these data to be synchronized include “favorites”, “my document”, “content list” . . . etc.

Also, it is noted that, while in editing the same set of data among computers, repetitious data may be found in the same set.

Therefore, the work to develop a data synchronization system and an accompanying method for solving foregoing problems would be highly and definitely welcome in the art.

### SUMMARY OF THE INVENTION

It is an object of the invention to provide a data synchronization system and a method for synchronizing data in a terminal and that in a server through networking. Thereby, a user can edit data in multiple far-end computers located at respective places through networking, or several users can edit simultaneously on their own computers in the same network at different places. By providing this invention, data of these computers can be kept consistency anytime, and thus new data can always be available in all computers.

It is another object of this invention to provide a data synchronization system and method which can efficiently and rapidly transmit and synchronize the difference of the data between the terminal and the server through networking.

According to this invention, the data synchronization system and method for synchronizing the data in a server and the data in the terminal through the network are introduced. The data comprise a characteristic data and a content data. The data synchronization system comprises a terminal receiver, a characteristic data difference distinguishing module, an exactor, a content data difference distinguishing module, a composing module, an editing module, and a terminal transmitting module.

The terminal receiver is used to receive the characteristic data from the server and the content data corresponding to the characteristic data from the server. The characteristic data difference distinguishing module can compare the characteristic data from the server with the characteristic data in the terminal to generate a first difference.

The exactor can compare the characteristic data in the server corresponding to the first difference with the characteristic data in the terminal, and can choose characteristic data in the server according to a predetermined condition. Afterward, the terminal receiver in the terminal can receive the content data corresponding to the characteristic data from the server.

The content data difference distinguishing module is used to compare the content data from the server with the content data in the terminal to generate a first content data difference. The composing module is used to combine the first content data difference and the content data in the terminal to generate a content renew data, and to combine the characteristic data in the terminal and the first difference to generate an index renew data. Further, the composing module can integrate the content renew data and the index renew data so as to generate a first renew data. Thereby, the data synchronization system can synchronize the first renew data in the terminal with the data in the server.

The editing module is used for editing the first renew data into a second renew data, and for editing the characteristic data corresponding to the second renew data. The characteristic data difference distinguishing module can compare the characteristic data of the second renew data and the index renew data to generate a second difference. The content data difference distinguishing module can compare the content data of the second renew data and the content renew data to generate a second content data difference. Subsequently, the terminal transmitting module can transmit the second content data difference and the second difference to the server through the network. Thereby, this invention can synchronize the second renew data in the terminal with the data in the server.

Therefore, by providing the data synchronization system and method of this invention and further using the technique of difference choosing mentioned above, the data in the terminal and the data in the server can be synchronized. Thereby, the user can edit data in multiple computers at various places through networking, or several users can edit data in their own computer at different places at the same time. This invention can keep these data of these computers consistency anytime, and can store these new data for preventing data loss in any computer. In addition, the data synchronization system and method of the present invention use simply the difference of the data between the terminal and the server in the network transmission, so that the data synchronization of the system can be efficiently and rapidly achieved.

### BRIEF DESCRIPTION OF THE APPENDED DRAWINGS

The advantage and spirit of the invention may be understood by the following recitations together with the appended drawings;

FIG. 1 shows a diagram of a convention network having multiple computers;

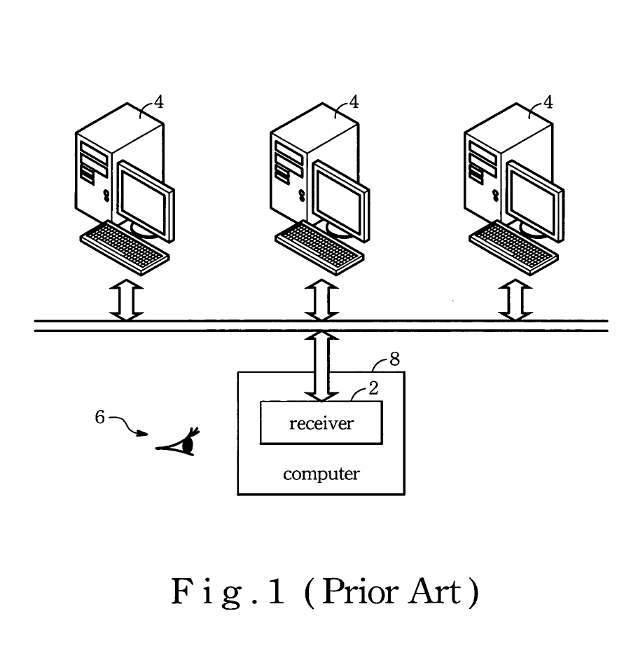

FIG. 2 shows a network structure for the data synchronization system of the present invention;

FIG. 3 shows a first embodiment of the data synchronization system in according with the present invention;

FIG. 4 shows a diagram of the server in the first embodiment;

FIG. 5 shows a diagram of an application of the first embodiment;

FIG. 6 shows a second embodiment of the data synchronization system in according with the present invention;

FIG. 7 shows a diagram of an application of the second embodiment; and

FIG. 8 shows a flow chart of the data synchronization method in according with the present invention.

### DETAILED DESCRIPTION OF THE INVENTION

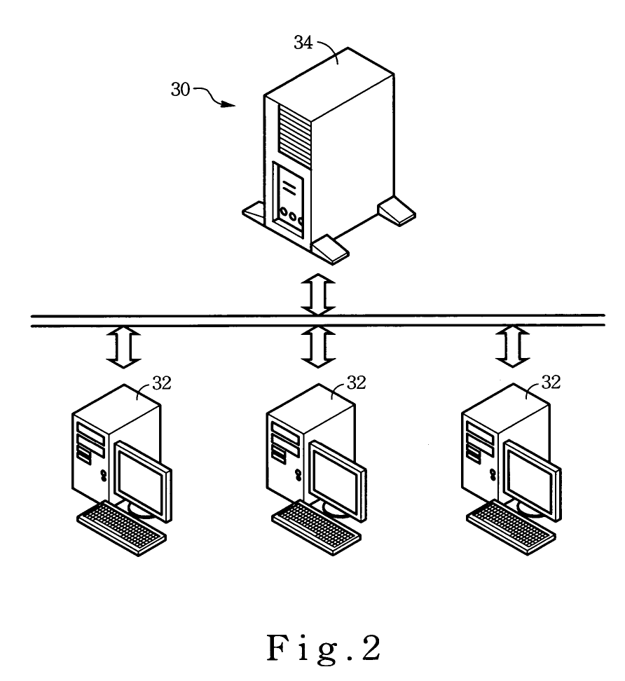

Referring to FIG. 2, it shows a preferred network structure for the data synchronization system in according with the present invention. This invention relates to a data synchronization system 30 for synchronizing data in a server 34 and data in the terminal 32 through a peer-to-peer network. Thereby, the multiple terminals 32 can work corporately through networking. Moreover, this invention can keep these data of these terminals 32 and server 34 consistency anytime, such that data loss in any computer can be reduced to a minimum. Further, the data synchronization system 30 can synchronize data both in the terminals and the server efficiently. In the present invention, the data synchronization system 30 can be installed in any terminal 32 or in the server 34, or partly in the terminal 32 and partly in the server 34. In the following description, two embodiments will be used to detail how the transmission efficiency of the network data can be increased without the compressing technique.

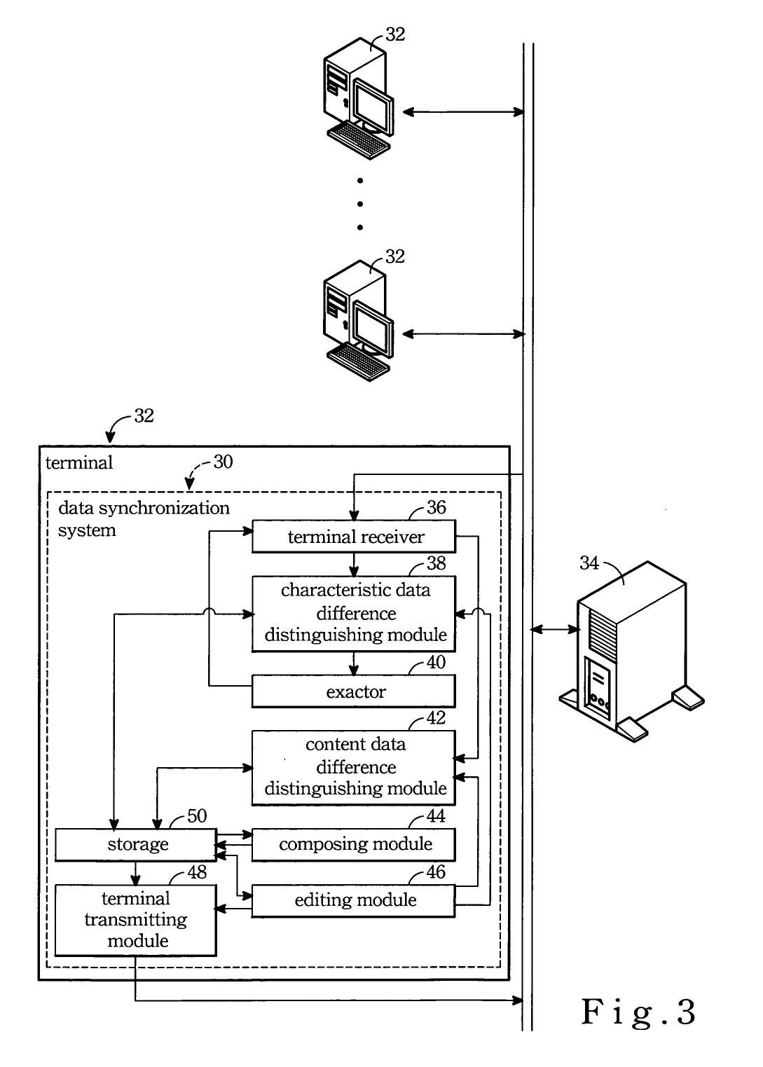

Referring now to FIG. 3, it shows a first embodiment of the data synchronization system 30 of the present invention. The first embodiment relates to a data synchronization system 30 installed in every terminal 32. The data synchronization system 30 can synchronize the data both in the terminal 32 and in the server 34 through the network. The data comprises a characteristic data and a content data. The data synchronization system comprises a terminal receiver 36, a characteristic data difference distinguishing module 38, an exactor 40, a content data difference distinguishing module 42, a composing module 44, an editing module 46, and a terminal transmitting module 48. The characteristic data can comprise file names, recording times, file sizes, file types, file abstracts, file writers, full text characteristic codes, and content characteristic codes.

In the present invention, these data can exist in various file types. Using MD5, SHA, or any the like, the data synchronization system 30 can process the data to generate a unique full text characteristic code, and thus can generate a unique characteristic data corresponding to the original data. For the characteristic data occupies smaller memory capacity, so it can be transmitted easily through networking.

Besides, a full text comprises several paragraphs of content. Each paragraph of content may be processed to generate a content characteristic code, and so characteristic data can be divided into many smaller characteristic data. The characteristic data corresponding to the content characteristic code is smaller than the characteristic data corresponding to the full text characteristic code, and so the divided characteristic data corresponding to the content characteristic code is more easily to be transmitted through networking.

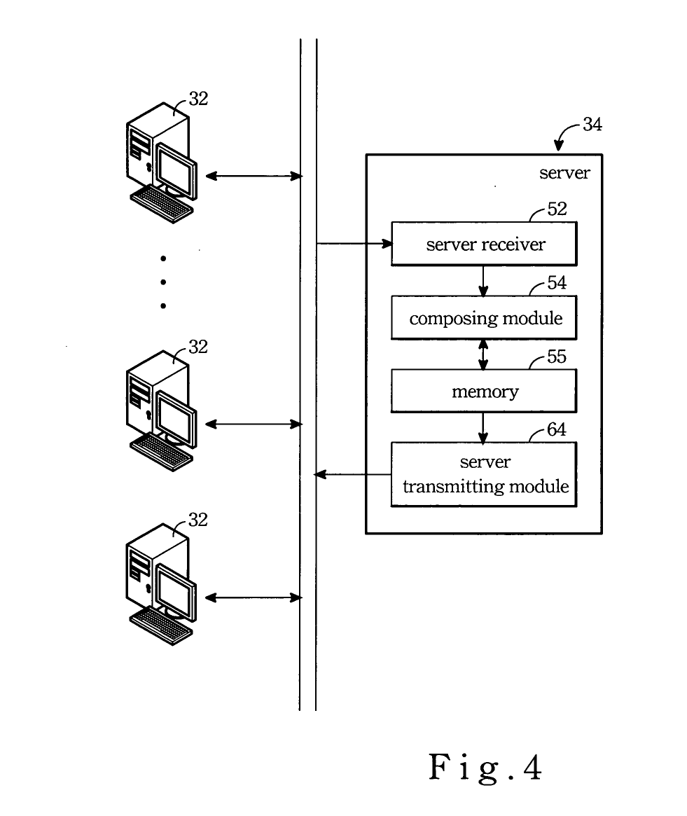

In addition, the data synchronization system 30 shown in FIG. 4 can further include a storage 50.

The terminal receiver 36 is used to receive the characteristic data of the data from the server 34, and to receive the content data corresponding to the characteristic data from the server 34. The characteristic data difference distinguishing module 38 compares the characteristic data of the data from the server 34 with the characteristic data of the data in the terminal 32 so as to generate a first difference. In other words, the characteristic data difference distinguishing module 38 compares these characteristic data of the data in the computers 32 and the server 34 further to generate the first difference. These characteristic data includes file names, recording times, file sizes, file types, file abstracts, file writers . . . etc. In this embodiment, the characteristic data and the first difference can be saved in the storage 50.

Subsequently, the exactor 40 compares the characteristic data in the server 34 corresponding to the first difference with the characteristic data in the terminal 32, and chooses characteristic data in the server 34 according to a predetermined condition. Afterward, a terminal receiver 36 receives the content data corresponding to the characteristic data from the server 34 through networking. The content data received can be saved in the storage 50 of the terminal 32.

Following describes the first difference and the predetermined condition of the invention. Firstly, the characteristic data difference distinguishing module 38 compares each file name of the characteristic data in the terminal 32 and in the server 34. If any difference in file names exist between the terminal 32 and the server 34, the first difference can then be generated.

In the case that data in the server 34 has the file name difference with the data in the terminal 32, it means that the data corresponding to the difference file name in the server 34 does not exist any more in the terminal 32. Subsequently, the terminal receiver 36 receives the content data corresponding to the different file name from the server 34. The algorithm just described is one of the predetermined conditions to the exactor 40.

In the case that the file name of the data in the server 34 exists already in the terminal 32. The characteristic data difference distinguishing module 38 will proceed to compare other characteristic data till a first difference is located. For example, the characteristic data difference distinguishing module 38 can compare these recording times of these data having the same file name. If these recording times of these same file name date are different, the exactor 40 can choose the characteristic data of the latest recording time, and gets the corresponding content data from the server 34. Similarly, choosing the characteristic data of the latest recording time is another predetermined condition of the present invention. Consequently, this invention synchronizes these data among these computers, server 34 or terminals 32.

On the other hand, characteristic data difference distinguishing module 38 compares other characteristic data, e.g. the predetermined file writer of the data, if these data have the same file name. If the file writers is different, then another first difference concerning the file writer is generated. The exactor 40 exacts the content data according to the priority of the file writer which is predetermined. Consequently, this invention synchronizes these data between these computers.

The terminal receiver 36 in the terminal 32 receives the content data corresponding to the characteristic data exacted by the exactor 40 from the server 34. That is, the terminal receiver 36 receives the content data which exists different characteristic data from the server 34. The different characteristic data could be different in file names. Subsequently, the content data difference distinguishing module 42 compares the content data from the server 34 received by the terminal receiver 36 with the content data in the terminal 32, and generates a first content data difference. Further, the first content data difference is stored in the storage 50.

In the present invention, subsequently, the composing module 44 composes the first content data difference and the content data stored in the storage 50 of the terminal 32 to generate a content renew data. Further, the composing module 44 composes characteristic data stored in the storage 50 of the terminal 32 and the first difference to generate an index renew data. Further, the composing module 44 composes the content renew data and the index renew data to generate a first renew data. Thereby, the data synchronization system synchronizes the first renew data in the terminal 32 and the data in the server 34. Thee first renew data is then stored in the storage 50.

In the present invention, the editing module 46, for example a Microsoft Word, in the data synchronization system 30, is used for editing the first renew data such as an original text content downloaded to generate a second renew data such as the modified text content, and further for editing the characteristic data, such as recording times or file writers, corresponding to the second renew data. Subsequently, the characteristic data difference distinguishing module 38 compares the characteristic data of the second renew data with the index renew data to generate a second difference. The content data difference distinguishing module 42 compares the content data of the second renew data with the content renew data so as to generate a second content data difference.

The second renew data and the second content data difference generated by the editing module 46 can be stored in the storage 50. Afterward, the terminal transmitting module 48 transmits the second content data difference and the second difference to the server 34 through networking. Thereby, the data in the server 34 can be renewed by receiving the second content data difference and the second difference as mentioned. Upon such an arrangement, the data synchronization system 30 can synchronize the second renew data in the terminal 32 and the data in the server 34.

Further, after the exactor 40 chooses the characteristic data from the server 34 and before the terminal receiver 36 in the terminal 32 receives the content data corresponding to the characteristic data, the characteristic data difference distinguishing module 38 can compare the characteristic data, the full text characteristic code and the characteristic code among the server 34 and the terminals 32, and can distinguish the difference. If the difference in the full text characteristic codes between the server 34 and terminal 32 exists, the difference distinguishing module 38 could further distinguish the difference of the characteristic code between the server 34 and terminal 32. In the present invention, the terminal receiver 36 in the terminal 32 can only receive the content data corresponding to the characteristic code having difference.

In addition, the exactor 40 in the data synchronization system 30 chooses the data of the first content data difference and the first difference between the server 34 and the terminal 32 during a predetermined period time. Afterward, the composing module 44 composes these differences to generate the first renew data. For instance, the exactor 40 can only choose the first content data difference and the first difference of the data between the server 34 and the terminal 32 in a week for the user to edit these data.

Besides, the exactor 40 in the data synchronization system 30 can choose the data from the server file document in the server 34, or can choose the data from the terminal file document in the terminal 32. Afterward, the data synchronization system 30 further compares and finds these first content data differences and the first differences within the predetermined file document in the server 34 and in the terminal 32. For example, the server file document and the terminal file document can be assigned to each own folder named the same “Railway Building-Operating-Transferation Plan”, or can be stored in a Local Cache in a memory of the computer. Then, the editor can edit all files in these same name file document.

Besides, the exactor 40 in the data synchronization system 30 can choose the data in the predetermined file type, such as the attached file named “.doc”, from the server 34 or the terminal 32 to further generate the first content data difference and the first difference. Consequently, the first renew data can be generated by the composing module 44.

Referring now to FIG. 4, it shows the infrastructure of the server 34 in the first embodiment. The server 34 comprises a server receiver 52, a composing module 54, a memory 55, and a server transmitting module 64. The server receiver 52 receives the second content data difference and the second difference from the terminal 32 through the network. The composing module 54 composes the second content data difference and the second difference in the terminal 32 with the content data of the data in the memory 55 and the characteristic data in the server 34 to further generate a server renew data, and stores these data in the memory 55 of the server 34. Subsequently, the server transmitting module 64 transmits the server renew data to other terminal 32 through the network for data synchronization. Thereby, this invention synchronizes the second renew data in the terminal 32 with the server renew data in the server 34.

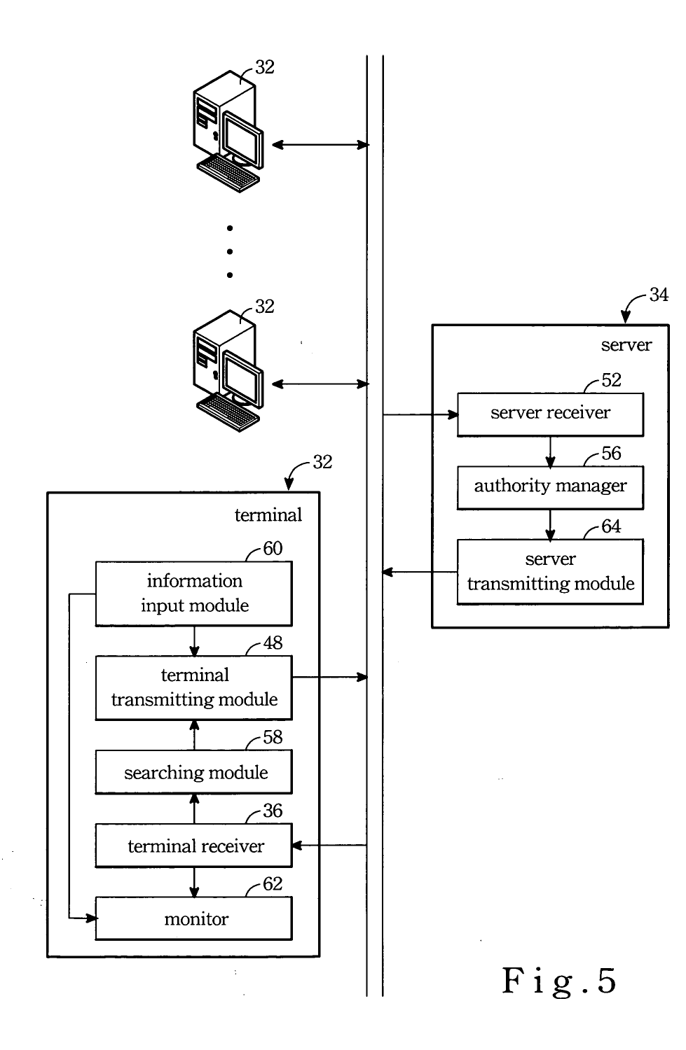

Further referring to FIG. 5, it is a further description of the first embodiment. The server 34 further comprises an authority manager 56. The terminal 32 further comprises a searching module 58, an information input module 60, and a monitor 62. The authority manager 56 is used for allowing the terminal 32 to download data from the server 34. The authority manager 56 transmits a confining command to the predetermined terminal 32 by the server transmitting module 64, and thereby the authority manager 56 can manage the data editing authority of these terminals 32.

In this invention, the searching module 58 in the terminal 32 is used for inputting a searching key word and searching the predetermined data in the server 34 via the terminal transmitting module 48. Subsequently, the terminal receiver 36 in the terminal 32 can receives the data been located by the searching module 58. The information input module 60 is used to input a first chat information. The terminal transmitting module 48 can transmit the first chat information to other terminals 32. The monitor 62 is used for displaying the first chat information and the second chat information received by the terminal receiver 36 from other terminal 32.

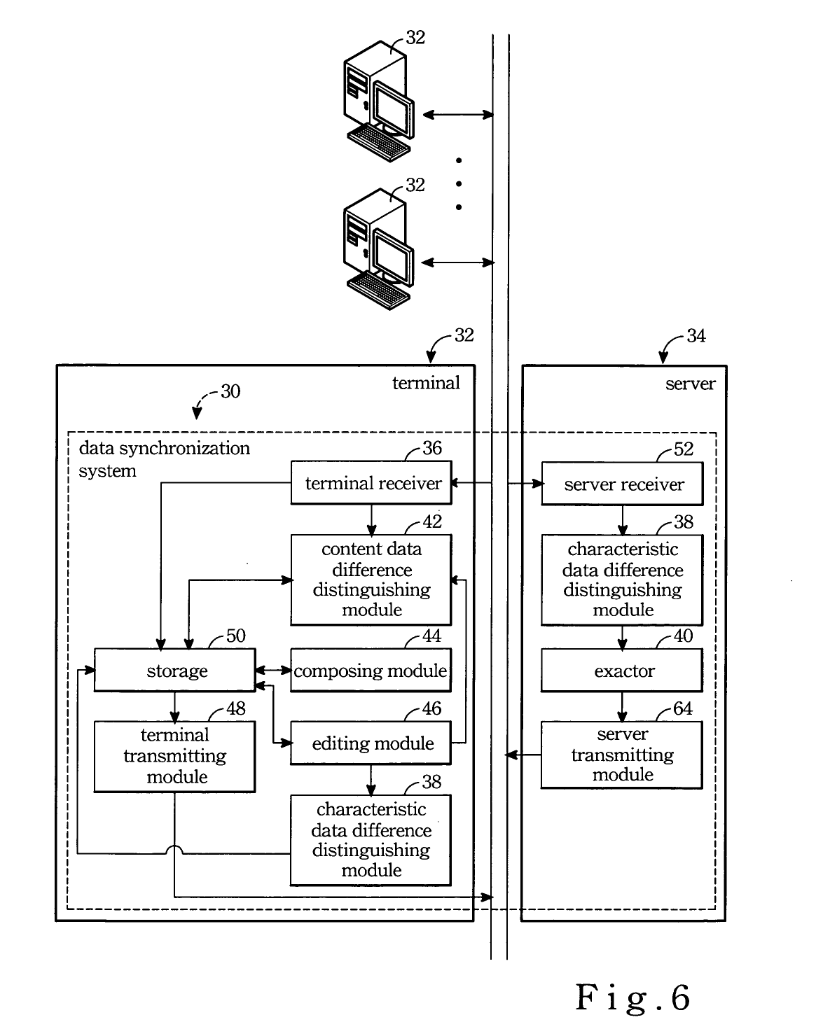

Referring to FIG. 6, it shows the second embodiment of the data synchronization system in accordance with the present invention. The data synchronization system 30 of this invention is utilized to synchronize data between the terminals 32 and the server 34 via networking. Further, the data synchronization system 30 can be separately sited in the terminal 32 and the server 34.

The data synchronization system 30 of the second embodiment, similar to the first embodiment, can comprise a server receiver 52, a characteristic data difference distinguishing module 38, an exactor 40, a server transmitting module 64, a terminal receiver 36, a content data difference distinguishing module 42, a composing module 44, an editing module 46, a terminal transmitting module 48, and a storage 50.

The server receiver 52 is located in the server 34. It is used for receiving the characteristic data from the terminal 32 via the network. The characteristic data difference distinguishing module 38, located in the server 34, is used to compare the characteristic data received from the terminal 32 and the characteristic data in the server 34 to further generate a first difference.

Subsequently, the exactor 40, located in the server 34, can compare the characteristic data corresponding to the first difference in the server 34 with the characteristic data in the terminal 32, and can choose the characteristic data in the server 34 by the predetermined condition as described in the first embodiment.

In the second embodiment, one of the predetermined conditions is to compare the characteristic data, such as file names, between the server 34 and the terminal 32. If different file names exist, then the server transmitting module 64 would transmit the content data of the data corresponding to the file name from the server 34 to the terminal receiver 36 of the terminal 32.

When the same file name exists in the server 34 and the terminal 32, the exactor 40 can further compare other characteristic data for finding the other first difference. If the other first difference still exists, then the terminal receiver 36 of the terminal 32 can receive the characteristic data with the other first difference and receives the content data corresponding to the characteristic data, and the terminal 32 can then store these data into the storage 50. Subsequently, the content data difference distinguishing module 42 can compare these data so as to generate the first content data difference. Finally, the composing module 44 proceeds to compose the first renew data.

In this invention, subsequently, the server transmitting module 64 located in the server 34 can transmit the first difference of the characteristic data chosen from the server 34 and the content data corresponding to the characteristic data to the terminal 32. The terminal receiver 36 located in the terminal 32 receives the first difference and the content data from the server transmitting module 64.

In the present invention, the content data difference distinguishing module 42 is located in the terminal 32 and is used to compare the content data of the data received from the server 34 by the terminal receiver 36 and the content data of the data stored in the storage 50 of the terminal 32 so as to further generate a first content data difference. Afterward, the first content data difference can be stored in the storage 50, while the composing module 44 located in the terminal 32 can compose the first content data difference with the content data in the terminal 32 to further generate a content renew data. Also, the composing module 44 composes the first difference and the characteristic data of the data in the terminal 32 so as to generate an index renew data. Finally, the composing module 44 can compose the content renew data and the index renew data to further generate a first renew data, and then the first renew data is stored in the storage 50. Upon such an arrangement, the data synchronization system 30 can synchronize the first renew data in the terminal 32 and the data in the server 34.

In the present invention, the editing module 46 in the terminal 32 is used for editing a first renew data so as to generate a second renew data, and further for editing the characteristic data corresponding to the second renew data. The characteristic data difference distinguishing module 38 in the terminal 32 can compare the characteristic data of the second renew data with the index renew data to generate a second difference. The content data difference distinguishing module 42 can compare the content data of the second renew data with the content renew data to generate a second content data difference. Further, the second difference and the second content data difference can be stored in the storage 50, and be transmitted to the server 34 by the terminal transmitting module 48 via the network. Thereby, the data synchronization system 30 of the present invention can be used successfully to synchronize the data in the server 34 and the second renew data in the terminal 32.

The operation of the server 34 in the second embodiment can be referred to FIG. 4. As the first embodiment, the server receiver 52 of the second embodiment can receive the second content data difference and the second difference from the terminal 32, and subsequently the composing module 54 can compose the server renew data. Finally, the second embodiment of the invention can then synchronize the server renew data in the server 34 and the second renew data in the terminal 32.

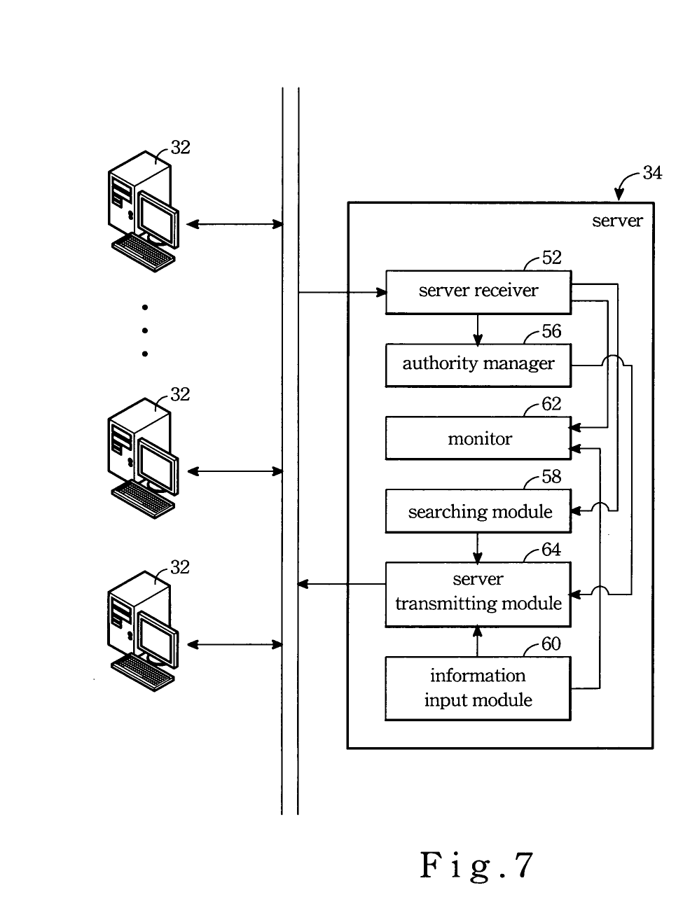

Referring now to FIG. 7, it shows a further description of the second embodiment. The server 34 can further comprise an authority manager 56 and a searching module 58. The terminal 32 can further comprise an information input module 60 and a monitor 62. The authority manager 56 is used for allowing the terminal 32 to download the data from the server 34. The authority manager 56 can transmit a confining command to the predetermined terminal 32 by the server transmitting module 64, and thereby the authority manager 56 can manage the data editing authority of these terminals 32. The searching module 58 in the terminal 32 is used for inputting a searching key word to search the predetermined data in the server 34 via the server receiver 52 and the server transmitting module 64. Subsequently, the terminal receiver 36 in the terminal 32 receives the data searched. The information input module 60 located in the server 34 is used to input a first chat information. The server transmitting module 64 can transmit the first chat information to other terminals 32. The monitor 62 located in the server 34 is used for displaying the first chat information and the second chat information received from other terminal 32 by the server receiver 52.

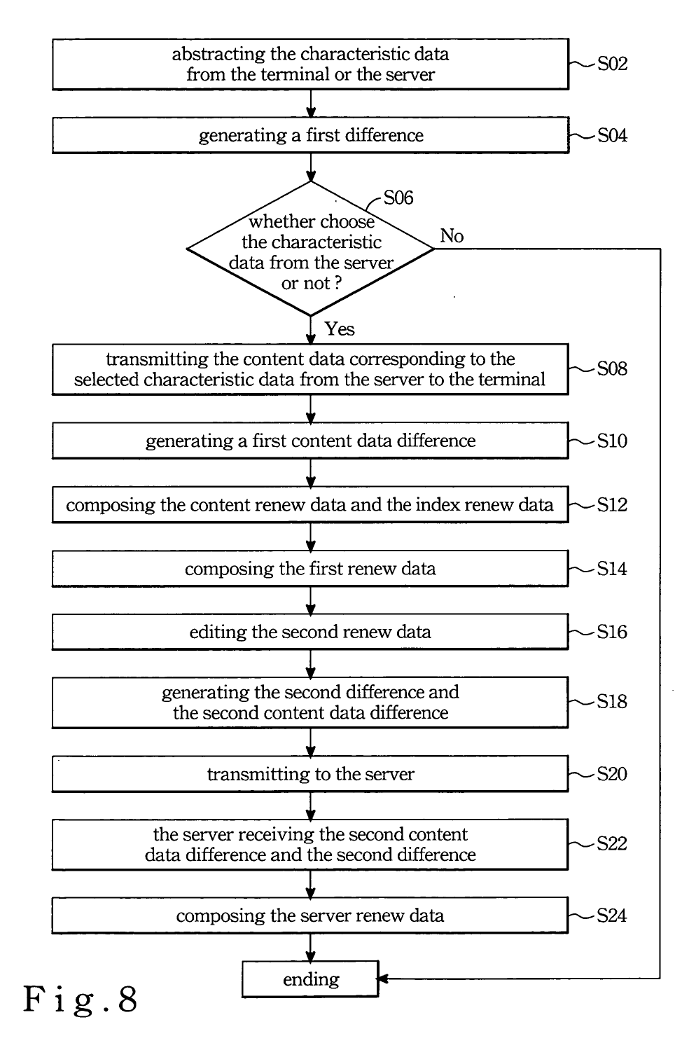

Referring to FIG. 8, a flow chart of the preferred data synchronization method in accordance with the present invention is shown. The data synchronization method is used to operate the data synchronization system 30 mentioned above. The object of the data synchronization method is to synchronize the data between the terminal 32 and the server 34 through the network. The data can comprise a characteristic data and a content data, wherein the characteristic data can comprise a file name, a recording time, a file size, a file type, a file abstract, and a file writer.

The data synchronization method can comprise following steps. Firstly, in step S02, the data synchronization system 30 can abstract the characteristic data from both the terminal 32 and the server 34. In step S04, the data synchronization system 30 compares these characteristic data to generate a first difference. In step S06, the data synchronization system 30 chooses one of these two characteristic data by a predetermined condition.

In step S08, the data synchronization system 30 transmits the content data corresponding to the selected characteristic data to the terminal 32. Next in step S10, the data synchronization system 30 compares the content data received from the server 34 with the content data in the terminal 32, and further generates a first content data difference.

Subsequently in step 12, the data synchronization system 30 composes the first content data difference and the content data in the terminal 32 to generate a content renew data, and also composes the characteristic data in the server 34 and the first difference to further generate an index renew data. Finally in step S14, the data synchronization system 30 composes the content renew data with the index renew data to generate a first renew data. Thereby, the data synchronization system 30 can synchronize the first renew data in the terminal 32 and the data in the server 34.

Furthermore in step S16, the data synchronization system 30 edits the first renew data to become a second renew data, and edits the characteristic data corresponding to the second renew data. In step S18, the data synchronization system 30 compares the characteristic data of the second renew data with the index renew data so as to generate a second difference, and compares the content data of the second renew data with the content renew data to further generate a second content data difference. Subsequently, in step S20, the second content data difference and the second difference are both transmitted to the server 34 through the network.

In step S22, the server 34 receives the second content data difference and the second difference from the terminal 32 via the network. In step S24, the data synchronization system 30 composes the second content data difference and the second difference with the content data and the characteristic data in the server 34 to generate a server renew data. Thereby, the data synchronization system 30 synchronizes the server renew data in the server 34 and the second renew data in the terminal 32.

The predetermined condition mentioned above comprises a different file name between the terminal 32 and the server 34. If different file names exist between the terminal 32 and the server 34, then the data synchronization system 30 would transmit the content data corresponding to the file name from the server 34 to the terminal 32. If the same file name exists in the terminal 32 and the server 34, then the data synchronization system 30 can further compare the characteristic data by other predetermined condition, and processes the same procedure as above-mentioned.

The other predetermined condition could be “comparing the recording time of the data”, with which the data synchronization system 30 can choose the latest content data of the data. Also, the other predetermined condition could be “comparing the predetermined priority of the file writer”, with which the data synchronization system 30 can choose the prior content data of the data edited by the priority file writer.

The other predetermined condition could be “choosing the file type predetermined’, with which the data synchronization system 30 can choose the first content data difference and the first difference of the data belonging to the file type predetermined from the terminal 32 or the server 34 and can then compose the first renew data. The other predetermined condition could be “choosing the first content data difference and the first difference of the data recorded during a predetermined period time and composing the first renew data afterward”. In addition. One more predetermined condition could be “choosing the first content data difference and the first difference from a predetermined file document and composing the first renew data afterward”.

Therefore, by providing the data synchronization system 30 and method of this invention, and further the technique of difference choosing above-mentioned, this invention can synchronize the data between the terminal 32 and the server 34. Thereby, the user can edit data on multiple terminals 32 at various places through networking, or several users can edit on their own terminal 32 at different places at the same time. Besides, this invention can keep these data of these computers 32, 34 consistency anytime, and can store these new data in time to prevent from data loss in any computer 32, 34. In addition to, the data synchronization system 30 and method of the present invention use only the technique of transmitting the difference of the data between the terminal 32 and the server 34 through networking and thus can promote efficiency and speed in synchronizing these data.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

1. A data synchronization system, sited in a terminal thereof for synchronizing data in a server thereof through a network, the data comprising a characteristic data and a content data, said data synchronization system comprising:
a terminal receiver for receiving the characteristic data of the data from the server through the network and for receiving the content data corresponding to the characteristic data from the server through the network;
a characteristic data difference distinguishing module for comparing the characteristic data from the server with the characteristic data in the terminal to further generate a first difference;
an exactor for comparing the characteristic data in the server corresponding to the first difference with the characteristic data in the terminal and for choosing the characteristic data in the server in accordance with a predetermined condition;
a content data difference distinguishing module for comparing the content data from the server received by the terminal receiver with the content data in the terminal and for further generating a first content data difference; and
a composing module for constituting the first content data difference with the content data in the terminal to generate a content renew data, for constituting the characteristic data in the terminal with the first difference to generate an index renew data, and further for constituting the content renew data with the index renew data to generate a first renew data.

2. The data synchronization system according to claim 1 further comprising:
an editing module for editing the first renew data into a second renew data and for editing the characteristic data corresponding to the second renew data, wherein the characteristic data difference distinguishing module compares the characteristic data of the second renew data with the index renew data to further generate a second difference, wherein the content data difference distinguishing module compares the content data of the second renew data with the content renew data to further generate a second content data difference; and
a terminal transmitting module for transmitting the second content data difference and the second difference to the server through the network.

3. The data synchronization system according to claim 2, wherein the server further comprises:
a server receiver for receiving a second content data difference and a second difference in the terminal through the network; and
a composing module for constituting the second content data difference and the second difference from the terminal with the content data and the characteristic data in the server to further generate a server renew data.

4. The data synchronization system according to claim 1, wherein the characteristic data comprise a file name, a recording time, a file size, a file type, a file abstract, a file writer, a full text characteristic code, and a content characteristic code.

5. The data synchronization system according to claim 4, wherein the predetermined condition is to compare these file names of characteristic data between the terminal and the server so as to find different file names.

6. The data synchronization system according to claim 5, wherein the exactor further compares and finds other characteristic data difference in the server and the terminal depending on another predetermined condition when the file in the server has the same file name in the terminal.

7. The data synchronization system according to claim 6, wherein the predetermined condition further comprises “distinguishing the newer file depending on the recording time of the file”; that is, the exactor getting the same file name content data in the server with a latest recording time.

8. The data synchronization system according to claim 7, wherein the exactor exacts the content data corresponding to a unique content characteristic code.

9. The data synchronization system according to claim 6, wherein the predetermined condition further comprises “finding a priority of the file writer and choosing the content data in the server corresponding to the file writer”.

10. The data synchronization system according to claim 6, wherein the predetermined condition further comprises “to choose the file recorded during a predetermined period time”.

11. The data synchronization system according to claim 6, wherein the exactor exacts these first content data difference and the first difference from the predetermined file document in the server and in the terminal.

12. A data synchronization system, for synchronizing data in a server and a terminal through a network, the data comprising a characteristic data and a content data, said data synchronization system comprising:
a server receiver, sited in the server for receiving characteristic data of the data in the terminal through the network;
a characteristic data difference distinguishing module, sited in the server for comparing the characteristic data in the server with the characteristic data from the terminal to further generate a first difference;
an exactor, sited in the server for comparing the characteristic data in the server corresponding to the first difference with the characteristic data in the terminal and for choosing the characteristic data in the server in accordance to a predetermined condition;
a server transmitting module, sited in the server for transmitting the first difference and the content data corresponding to the characteristic data to the terminal through the network;
a terminal receiver, sited in the terminal for receiving the first difference and the content data through the network;
a content data difference distinguishing module, sited in the terminal for comparing the content data from the server received by the terminal receiver with the content data in the terminal and for further generating a first content data difference; and
a composing module, sited in the terminal for constituting the first content data difference with the content data in the terminal to further generate a content renew data, for constituting the characteristic data in the terminal with the first difference to generate an index renew data, and for further constituting the content renew data with the index renew data to generate a first renew data so as to synchronize the first renew data in the terminal with the data in the server.

13. The data synchronization system according to claim 12 further comprising:
an editing module, sited in the terminal for editing the first renew data into a second renew data and for editing the characteristic data corresponding to the second renew data, the characteristic data difference distinguishing module comparing the characteristic data of the second renew data with the index renew data to generate a second difference, the content data difference distinguishing module comparing the content data of the second renew data with the content renew data to generate a second content data difference; and
a terminal transmitting module, sited in the terminal for transmitting the second content data difference and the second difference to the server through the network so as to synchronize the second renew data in the terminal with the data in the server.

14. The data synchronization system according to claim 13, wherein the server receiver receives the second content data difference and the second difference in the terminal through the network, the server further comprising:
a composing module for constituting the second content data difference from the terminal and the second difference from the terminal with the content data in the server and the characteristic data in the server so as to generate a server renew data for synchronizing the server renew data in the server with the second renew data in the terminal.

15. The data synchronization system according to claim 12, wherein the characteristic data comprises a file name, a recording time, a file size, a file type, a file abstract, a file writer, a full text characteristic code, and a content characteristic code.

16. The data synchronization system according to claim 15, wherein the predetermined condition is “comparing the file name of characteristic data between terminal and server and further finding the different file name”.

17. The data synchronization system according to claim 16, wherein the exactor further compares and finds other characteristic data difference in the server and the terminal depending on another predetermined condition when the file name corresponding to the file in the server exists in the terminal.

18. The data synchronization system according to claim 17, wherein the predetermined condition further comprises “distinguishing a latest file depending on the recording time of the file, and the exactor exacting the same file name content data in the server with a latest recording time”.

19. The data synchronization system according to claim 18, wherein the exactor exacts the content data corresponding to a unique content characteristic code.

20. The data synchronization system according to claim 17, wherein the predetermined condition further comprises “finding a priority of file writer and choosing the content data in the server corresponding to the file writer”.

21. The data synchronization system according to claim 17, wherein the predetermined condition further comprises “choosing the file recorded during a predetermined period time”.

22. The data synchronization system according to claim 17, wherein the exactor exacts these characteristic data from the predetermined file document in the server and in the terminal.

23. A data synchronization method for synchronizing data in a server and a terminal through a network, the data comprising a characteristic data and a content data, said data synchronization method comprising:
exacting the characteristic data from the server and the characteristic data from the terminal;
comparing the characteristic data from the server with the characteristic data from the terminal to generate a first difference;
comparing the characteristic data in the server corresponding to the first difference with the characteristic data in the terminal, and choosing characteristic data in the server in accordance to a predetermined condition;
transmitting the content data corresponding to the characteristic data chosen to the terminal through the network;
comparing the content data from the server with the content data in the terminal, and generating a first content data difference;
constituting the first content data difference with the content data in the terminal to generate a content renew data, and constituting the characteristic data in the server with the first difference to generate an index renew data; and
constituting the content renew data with the index renew data to generate a first renew data so as to synchronize the first renew data in the terminal with the data in the server.

24. The data synchronization method according to claim 23, further comprising the steps of:
editing the first renew data becoming to a second renew data, and editing the characteristic data corresponding the second renew data;
comparing the characteristic data of the second renew data with the index renew data to generate a second difference, and comparing the content data of the second renew data with the content renew data to generate a second content data difference; and
transmitting the second content data difference and the second difference to the server through the network for further synchronizing the second renew data in the terminal with the data in the server.

25. The data synchronization method according to claim 24, further comprising steps of:
receiving a second content data difference and a second difference from the terminal through the network; and
constituting the second content data difference and the second difference with the content data in the server and the characteristic data in the server to generate a server renew data so as to synchronize the server renew data in the server with the second renew data in the terminal.

26. The data synchronization method according to claim 23, wherein the characteristic data comprises a file name, a recording time, a file size, a file type, a file abstract, a file writer, a full text characteristic code, and a content characteristic code.

27. The data synchronization method according to claim 26, wherein the predetermined condition is “comparing the file name of characteristic data between the terminal and the server, and finding the different file name”.

28. The data synchronization method according to claim 27, further comprising a step of comparing and finding other characteristic data difference in the server and the terminal depending on the predetermined condition when the file name corresponding to the file in the server exists in the terminal.

29. The data synchronization method according to claim 28, wherein the predetermined condition further comprises “distinguishing a latest file depending on the recording time of the file, and exacting the same file name content data in the server with the latest recording time.

30. The data synchronization method according to claim 29, wherein the content data exacted is the unique content characteristic code.

31. The data synchronization method according to claim 28, further comprising step of finding a priority of file writer, and choosing the content data in the server corresponding to the file writer.

32. The data synchronization method according to claim 28, wherein the predetermined condition further comprises “choosing the file recorded during a predetermined period time”.

33. The data synchronization method according to claim 28, wherein the predetermined condition further comprises “comparing and finding these first content data difference and the first difference within the predetermined file document in the server and in the terminal”.
